(19) United States
(12) Patent Application Publication
(10) Pub. No.: US 2013/0117245 A1
(43) Pub. Date: May 9, 2013

(54) METHOD AND SYSTEM FOR IDENTIFICATION OF ASSET RECORDS IN A VERSION MANAGED DATASTORE

(71) Applicant: Phillip James Robinson, Cambridge (GB)

(72) Inventor: Phillip James Robinson, Cambridge (GB)

(73) Assignee: General Electric Company

(21) Appl. No.: 13/291,213

(22) Filed: Nov. 8, 2011

(51) Int. Cl. G06F 7/00

(52) U.S. Cl. 707/695; 707/E17.005

(57) ABSTRACT

Described herein are embodiments of methods and systems and devices identification of asset records in a version managed datastore. In accordance with one aspect, a method is provided for identification of asset records in a version managed datastore. In one embodiment, the method includes: receiving an asset identifier, wherein the asset identifier is created as part of an asset record for a version of a version managed database; determining, using a processor, whether the asset identifier has been previously stored in an asset identity management database; sending a notice if the asset identifier has been previously stored in the asset identity management database; and storing at least the asset identifier in the asset identity management database if the asset identifier has not been previously stored in the asset identity management database.

### FIELD OF THE INVENTION

This invention generally relates to systems and methods of database management, and in particular, to systems and methods for identification of asset records in a version managed datastore.

### BACKGROUND OF THE INVENTION

In a version managed database, multiple versions (e.g. version 1, version 2, . . . , version n) of a database such as an asset database are created so that a plurality of users may simultaneously edit, change, add to, or revise the database. Once the changes are made, a version is merged back into the database. In some instances, there may be a duplication of efforts among the versions, which are generally not detected until the versions are merged back into the database. For example, the database may be an asset database that contains descriptive information of a graphical information system (GIS) for an electric utility distribution system. A version may be created to design a proposed extension to the distribution system. This extension can be comprised of assets such as poles, transformers, etc. Each of these assets has an asset record that is created when information about the asset is entered into the version. In some instances, different operators may inadvertently create asset records for the same asset in different versions. Heretofore, there was no way to detect this duplication until the versions were merged back into the database.

Therefore, methods and systems are desired that overcomes challenges in the art, some of which are described above, for identification of asset records in a version managed datastore.

### BRIEF DESCRIPTION OF THE INVENTION

Described herein are embodiments of methods and systems for identification of asset records in a version managed datastore. In particular, systems and methods are disclosed herein that provide an operator with information about the status of assets in a version managed database environment prior to the version being merged into that database.

In accordance with one aspect, a method is provided for identification of asset records in a version managed datastore. In one embodiment, the method includes: receiving an asset identifier, wherein the asset identifier is created as part of an asset record for a version of a version managed database; determining, using a processor, whether the asset identifier has been previously stored in an asset identity management database; sending a notice if the asset identifier has been previously stored in the asset identity management database; and storing at least the asset identifier in the asset identity management database if the asset identifier has not been previously stored in the asset identity management database.

In accordance with another aspect, a method is provided for identification of asset records in a version managed datastore. In one embodiment, the method includes: creating a version of a version managed database; creating an asset record for an asset to be added to the version of the version managed database, wherein the asset record includes an asset identifier; sending at least the asset identifier to an asset identity management server, wherein the asset identity management server determines whether the asset identifier has been previously stored in an asset identity management database on the asset identity management server; and receiving a notice if the asset identifier has been previously stored in the asset identity management database on the asset identity management server.

In accordance with yet another aspect, a system is described for identification of asset records in a version managed datastore. One embodiment of the system is comprised of: a communication interface; a memory; and a processor, wherein the processor is operably connected with the communication interface and the memory, and the processor is configured to: receive an asset identifier, wherein the asset identifier is created as part of an asset record for a version of a version managed database; determine whether the asset identifier has been previously stored in an asset identity management database stored on the memory; send a notice using the communication interface if the asset identifier has been previously stored in the asset identity management database stored on the memory; and store at least the asset identifier in the asset identity management database on the memory if the asset identifier has not been previously stored in the asset identity management database.

In another aspect, a system is described for identification of asset records in a version managed datastore. One embodiment of the system is comprised of: a communication interface; a memory; and a processor, wherein the processor is operably connected with the communication interface and the memory, and the processor is configured to: create a version of a version managed database; create an asset record for an asset to be added to the version of the version managed database, wherein the asset record includes an asset identifier; send, using the communication interface, at least the asset identifier to an asset identity management server, wherein the asset identity management server determines whether the asset identifier has been previously stored in an asset identity management database on the asset identity management server; and receive, using the communication interface, a notice if the asset identifier has been previously stored in the asset identity management database on the asset identity management server.

In yet another aspect, a system is described for identification of asset records in a version managed datastore. One embodiment of the system is comprised of: an asset identity management server, wherein the asset identity management server is associated with an asset identity management database; a network, wherein the network is operably connected to the asset identity management server; and a computing device, wherein the computing device is operably connected to the network, and wherein the computing device is configured to: create a version of a version managed database; create an asset record for an asset to be added to the version of the version managed database, wherein the asset record includes an asset identifier; send at least the asset identifier over the network to the asset identity management server; and receive a notice over the network from the asset identity management server if the asset identifier has been previously stored in the asset identity management database on the asset identity management server, wherein the asset identity management server is configured to: receive the asset identifier sent by the computing device over the network and determine whether the asset identifier has been previously stored in the asset identity management database on the asset identity management server; send a notice over the network to the computing device if the asset identifier has been previously stored in the asset identity management database; and store at least the asset identifier in the asset identity management database if the asset identifier has not been previously stored in the asset identity management database.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an overview block diagram of a system for identification of asset records in a version managed datastore according to one embodiment of the present invention;

FIG. 2 is a block diagram illustrating an exemplary operating environment for performing aspects of the disclosed methods;

FIG. 3 is an exemplary flowchart illustrating the operations that may be taken by the asset identity management server for identification of asset records in a version managed datastore according to one embodiment of the present invention; and

FIG. 4 is an exemplary flowchart illustrating the operations that may be taken by the computing device for identification of asset records in a version managed datastore according to one embodiment of the present invention.

### DETAILED DESCRIPTION OF THE INVENTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

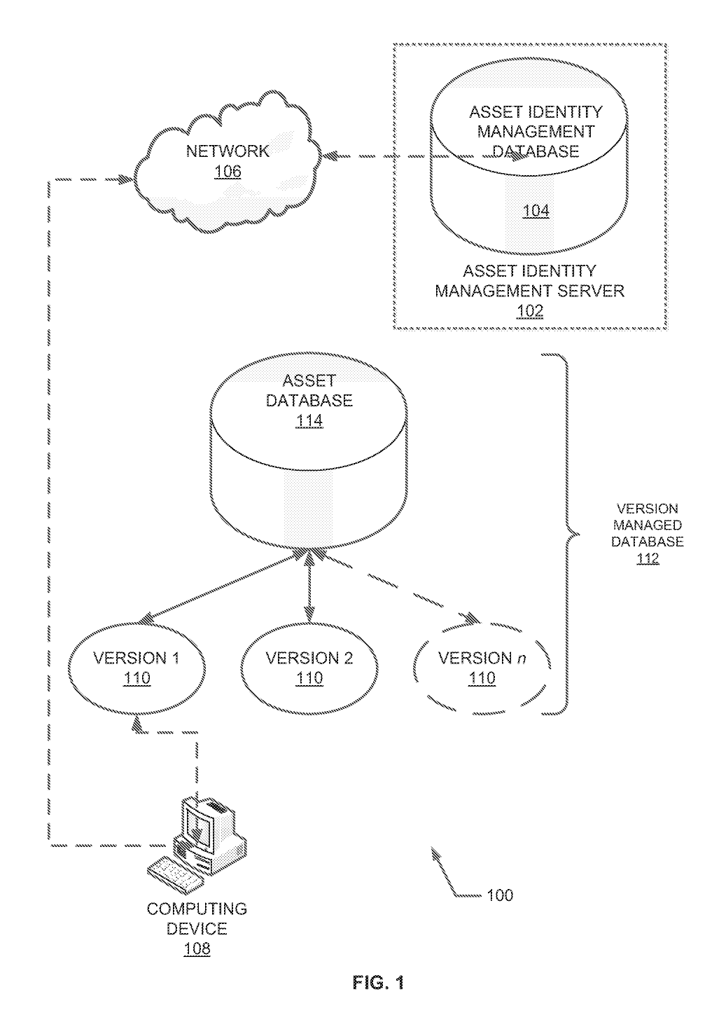

FIG. 1 is an overview block diagram of a system for identification of asset records in a version managed datastore according to one embodiment of the present invention. As shown in FIG. 1, this embodiment of a system 100 is comprised of an asset identity management server 102. Associated with the asset identity management server 102 is an asset identity management database 104. Further comprising the embodiment of a system 100 as shown in FIG. 1 is a network 106. The network 106 operably connects the asset identity management server 102 and one or more computing devices 108. The network 106 can be, for example, wired (including fiber optic), wireless, or a combination of wired and wireless. The network 106 can use any number of communication protocols. For example, the network 106 can be the Internet and utilize the http protocol. The computing device 108 is operably connected to the network 106. In one aspect, the computing device 108 is configured to create a version 110 of a version managed database 112. In a version managed database 112, multiple versions 110 (e.g. version 1, version 2, . . . , version n) of a database such as asset database 114 are created so that a plurality of users may simultaneously edit, change, add to, or revise the database 114. Once the changes are made, a version 110 is merged back into the database 114. In some instances, there may be a duplication of efforts among the versions 110, which are generally not detected until the versions 110 are merged back into the database 114. For example, the database 114 may be an asset database that contains descriptive information of a graphical information system (GIS) for an electric utility distribution system. A version 110 may be created to design a proposed extension to the distribution system. This extension can be comprised of assets such as poles, transformers, etc. Each of these assets has an asset record that is created when information about the asset is entered into the version 110. In some instances, different operators may inadvertently create asset records for the same asset in different versions 110. Heretofore, there was no way to detect this duplication until the versions 110 were merged back into the database 114. However, as shown in the embodiment of FIG. 1, a computing device 108 is configured to create a version 110 of a version managed database 112. In one aspect, all or part of the version managed database 112 can reside on the computing device 108. In another aspect, all or part of the version managed database 112 can reside on the asset identity management server 102. In other aspects, all or part of the version managed database 112 can reside on one or more servers that are not shown in FIG. 1.

Regardless of where the version managed database 112 resides, the computing device 108 is configured to create a version 110. As noted herein, there may be multiple, simultaneous versions 110, each residing on the computing device 108, or on other computing devices (not shown). The computing device 108 is further configured to create an asset record for an asset to be added to the version 110 of the version managed database 110. As noted above, the asset record includes descriptive information about an asset to be added to the database 114. In one aspect, the asset record includes an asset identifier. An asset identifier is a unique descriptor used to identify an asset according to a naming protocol. For example, the asset identifier may be a coordinate assigned to the location of a fixed asset, with a numerical or alphabetical extension. In another example, the asset identifier can be, for example, a number, letters or alphanumeric identifier assigned to an asset. An example might be a tag for a pole that takes the form “ST P 96746” where “ST P” stands for a “standard pole” and the number is a unique number. Similarly, “H 100273” can be an example of an asset id for a handhole. In one aspect, the asset identifier can be automatically generated by the computing device 108 based upon information about an asset. In another aspect, the asset identifier can be entered into the computing device 108 by a person. As noted herein, in one aspect, the asset identifier is created as part of the asset record for a version of a graphical information system (GIS) database.

In one aspect, the computing device 108 is configured to send at least the asset identifier from a newly-created asset record over the network 106 to the asset identity management server 102. The asset identity management server 102 is configured to receive the asset identifier sent by the computing device 108 over the network 106 and determine whether the asset identifier has been previously stored in the asset identity management database 104 on the asset identity management server 102. In one aspect, this is performed by comparing the asset identifier against all the asset identifiers that are already stored in the asset identity management database 104. In other aspects, the computing device 108 is configured to send information in addition to or other than the asset identifier from a newly-created asset record over the network 106 to the asset identity management server 102. For example, the computing device 108 may send location information, part number or serial number information, descriptive information and the like from the asset record to the asset identity management server 102, where the asset identity management server 102 can use the received information to determine whether the asset described by the asset record has previously been identified to the asset identity management database 104 on the asset identity management server 102. In one aspect, if the asset identity management server 102 determines that the asset has previously been identified to the asset identity management database 104, then the asset identity management server 102 is configured to send a notice over the network 106 to the computing device 108. In one aspect, the notice includes a globally unique identifier (GUID) for the asset. Generally the asset management identity server generates the GUID and assigns it to the asset. Generally, a GUID is a unique reference number used as an identifier in computer software. In one aspect, the value of a GUID is represented as a 32-character hexadecimal string, such as {21EC2020-3AEA-1069-A2DD-08002B30309D}, and is usually stored as a 128-bit integer. The total number of unique keys is 2¹²⁸ or 3.4×10³⁸. This number is so large that the probability of the same number being generated randomly twice is negligible. The GUID can be used by other versions 110 and the asset database 114 when referring to the asset. In one aspect, the notice indicates that the asset has previously been identified to the asset identity management database 104. In one aspect, the notice can include additional information such as who created the asset record for the asset, the date of creation, descriptive information about the asset, the GUID, and the like. In one aspect, if the asset identity management server 102 determines that the asset has not previously been identified to the asset identity management database 104, then the asset identity management server 102 is configured to store information about the asset in the asset identity management database 104. This information can include an asset identifier, who created the asset record for the asset, the date of creation, descriptive information about the asset, and the like. In one aspect, once the asset has been identified to the asset identity management server 102, the asset identity management server 102 is configured to send a notice over the network 106 to the computing device 108. In one aspect, the notice includes a globally unique identifier (GUID) for the asset as assigned by the asset identity management server 102. In one aspect, the GUID for an asset is stored in the asset identity management database 104 prior to the notice being sent.

The computing device 108 is configured to receive the notice over the network 106 from the asset identity management server 102. In one aspect, the notice indicates whether or not the asset identifier has been previously stored in the asset identity management database 104 on the asset identity management server 102. The notice can also include information such as a GUID for the asset.

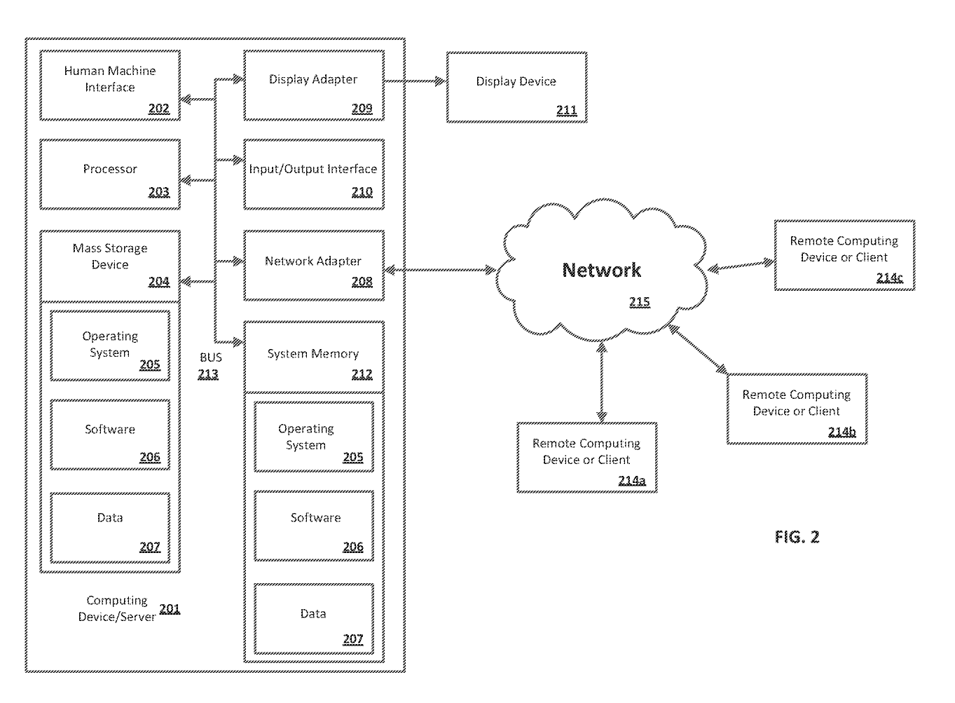

The above system 100 has been described above as comprised of units. One skilled in the art will appreciate that this is a functional description and that software, hardware, or a combination of software and hardware can perform the respective functions. A unit, such as a computing device 108, the asset identity management server 102, network 106, and the like can be comprised of hardware, or a combination of software and hardware. The units can comprise, for example, for software 206 for the identification of asset records in a version managed datastore, as illustrated in FIG. 2 and described below. In one exemplary aspect, the units can comprise a computing device 201 such as the computing device 108 and/or the asset identity management server 202 as illustrated in FIG. 1 and described above.

FIG. 2 is a block diagram illustrating an exemplary operating environment for performing aspects of the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, smart meters, smart-grid components, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a computing device in the form of a computer 201. The components of the computer 201 can comprise, but are not limited to, one or more processors or processing units 203, a system memory 212, and a system bus 213 that couples various system components including the processor 203 to the system memory 212. In the case of multiple processing units 203, the system can utilize parallel computing.

The system bus 213 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 213, and all buses specified in this description can also be implemented over a wired or wireless network connection and each of the subsystems, including the processor 203, a mass storage device 204, an operating system 205, software 206, data 807, a network adapter 208, system memory 212, an input/output interface 210, a display adapter 209, a display device 211, and a human machine interface 202, can be contained within one or more remote computing devices, clients or servers 214a,b,c at physically separate locations, connected through buses of this form, in effect implementing a fully distributed system or distributed architecture. For example, the computer 201 can represent the computing device 108 of FIG. 1 and the remote computing devices, clients or servers 214a,b,c can represent the asset identity management server 102 and other computing devices. Likewise, the computer 201 can represent the asset identity management server 102 of FIG. 1, and the remote computing devices, clients or servers 214a,b,c can represent one or more of the computing devices 108, as described above.

The computer 201 typically comprises a variety of computer readable media. Exemplary readable media can be any available media that is non-transitory and accessible by the computer 201 and comprises, for example and not meant to be limiting, both volatile and non-volatile media, removable and non-removable media. The system memory 212 comprises computer readable media in the form of volatile memory, such as random access memory (RAM), and/or non-volatile memory, such as read only memory (ROM). The system memory 212 typically contains data such as data 207 and/or program modules such as operating system 205 and software 206 that are immediately accessible to and/or are presently operated on by the processing unit 203.

In another aspect, the computer 201 can also comprise other non-transitory, removable/non-removable, volatile/non-volatile computer storage media. By way of example, FIG. 2 illustrates a mass storage device 204 that can provide non-volatile storage of computer code, computer readable instructions, data structures, program modules, and other data for the computer 201. For example and not meant to be limiting, a mass storage device 204 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 204, including by way of example, an operating system 205 and software 206. Each of the operating system 205 and meter communication software 206 (or some combination thereof) can comprise elements of the programming and the software 206. Data 207 can also be stored on the mass storage device 204. Data 807 can be stored in any of one or more databases known in the art. Examples of such databases comprise, DB2® (IBM Corporation, Armonk, N.Y.), Microsoft® Access, Microsoft® SQL Server, (Microsoft Corporation, Bellevue, Wash.), Oracle®, (Oracle Corporation, Redwood Shores, Calif.), mySQL, PostgreSQL, and the like. The databases can be centralized or distributed across multiple systems. For example, the databases can be the asset database 114 or the asset identity database 104 as described in relation to FIG. 1. For example, mass storage device 204 can be used to store executable code for performing the following steps (if the computer 201 is acting as the asset identity management server 102) of receiving an asset identifier, wherein the asset identifier is created as part of an asset record for a version of a version managed database; determining, using the processor 203, whether the asset identifier has been previously stored in an asset identity management database 207; sending a notice if the asset identifier has been previously stored in the asset identity management database 207; and storing at least the asset identifier in the asset identity management database 207 if the asset identifier has not been previously stored in the asset identity management database. Similarly, if acting as the computing device 108 of FIG. 1, the mass storage device 204 can be used to store executable code for performing the following steps of creating a version of a version managed database; creating an asset record for an asset to be added to the version of the version managed database, wherein the asset record includes an asset identifier; sending at least the asset identifier to an asset identity management server 102, wherein the asset identity management server 102 determines whether the asset identifier has been previously stored in an asset identity management database 104 on the asset identity management server 102; receiving a notice if the asset identifier has been previously stored in the asset identity management database 104 on the asset identity management server 102; and storing at least the asset identifier in the asset identity management database 104 on the asset identity management server 102 if the asset identifier has not been previously stored in the asset identity management database 104 on the asset identity management server 102.

In another aspect, the user can enter commands and information into the computer 201 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 203 via a human machine interface 202 that is coupled to the system bus 213, but can be connected by other interface and bus structures, such as a parallel port, game port, an IEEE 1394 Port (also known as a Firewire port), a serial port, or a universal serial bus (USB).

In yet another aspect, a display device 211 can also be connected to the system bus 213 via an interface, such as a display adapter 209. It is contemplated that the computer 201 can have more than one display adapter 209 and the computer 201 can have more than one display device 211. For example, a display device can be a monitor, an LCD (Liquid Crystal Display), or a projector. In addition to the display device 211, other output peripheral devices can comprise components such as speakers (not shown) and a printer (not shown), which can be connected to the computer 201 via input/output interface 210. Any step and/or result of the methods can be output in any form to an output device. Such output can be any form of visual representation, including, but not limited to, textual, graphical, animation, audio, tactile, and the like.

The computer 201 can operate in a networked environment using logical connections to one or more remote computing devices or clients 214a,b,c. By way of example, a remote computing device 214 can be a personal computer, portable computer, a server, a router, a network computer, a smart meter, a vendor or manufacture's computing device, smart grid components, a peer device or other common network node, and so on. Logical connections between the computer 201 and a remote computing device or client 214a,b,c can be made via a local area network (LAN) and a general wide area network (WAN). Such network connections can be through a network adapter 208. A network adapter 208 can be implemented in both wired and wireless environments. Such networking environments are conventional and commonplace in offices, enterprise-wide computer networks, intranets, and other networks 215 such as the Internet.

For purposes of illustration, application programs and other executable program components such as the operating system 205 are illustrated herein as discrete blocks, although it is recognized that such programs and components reside at various times in different storage components of the computing device 201, and are executed by the data processor(s) of the computer. An implementation of the software 206 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

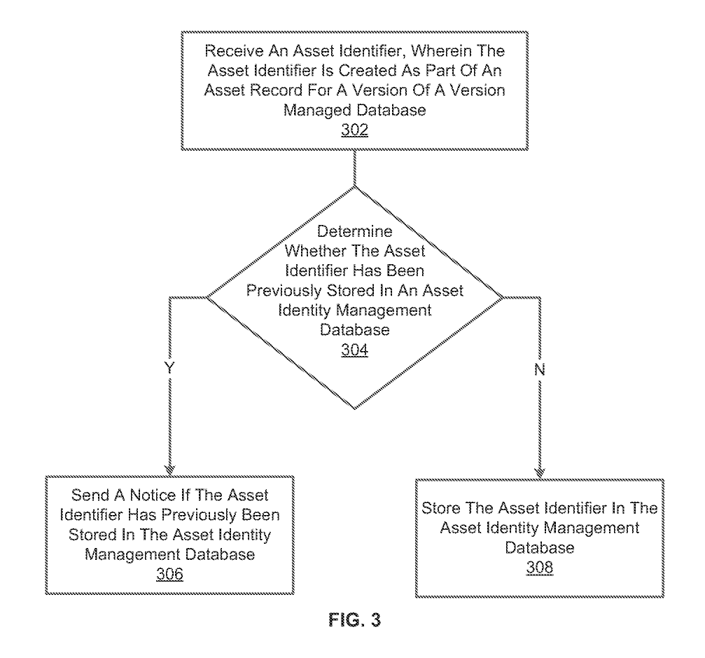

FIG. 3 is a flowchart illustrating the operations that may be taken by the asset identity management server 102 for identification of asset records in a version managed datastore according to one embodiment of the present invention. At step 302, the asset identity management server 102 receives an asset identifier, wherein the asset identifier is created as part of an asset record for a version 110 of a version managed database 112. At step 304, the asset identity management server 102 determines, using is processor, whether the asset identifier has been previously stored in an asset identity management database 104. At step 306, the asset identity management server 102 sends a notice if the asset identifier has been previously stored in the asset identity management database 104. In one aspect, the notice can include a GUID for the asset identified by the asset identifier. At step 308, at least the asset identifier is stored in the asset identity management database 104 if the asset identifier has not been previously stored in the asset identity management database. In one aspect, the asset identified by the asset identifier can be assigned a GUID prior to storing the asset identifier is stored in the asset identity management database 104. In one aspect, the GUID can be included in a notice that is sent to the sender of the asset identifier.

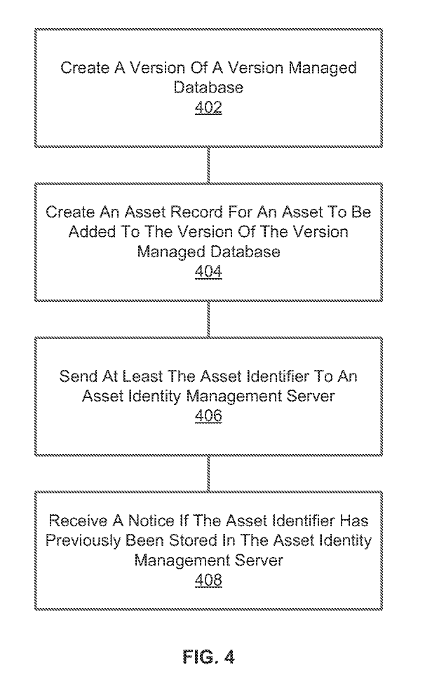

FIG. 4 is a flowchart illustrating the operations that may be taken by the computing device 108 for identification of asset records in a version managed datastore according to one embodiment of the present invention. At step 402, a version 110 of a version managed database is created. As noted herein, version managed databases are known in the art and allow multiple users to add, change, or modify the database simultaneously by each user creating and editing a version 110 of the main database 114. Once the changes are made to the version 110, the version 110 is merged back into the main database 114. At step 404, an asset record is created for an asset to be added to the version 110 of the version managed database 114, wherein the asset record includes an asset identifier. For example, an operator can be designing an extension to a utility distribution system such as an electric power distribution system, water, natural gas, or the like. The asset could be a meter for the distribution system. The asset record can include an asset identifier for the meter. In one aspect, the asset identifier is created per a protocol of the utility. In one aspect, the asset identifier is created automatically by the computing device 108 when the asset record is created. In one aspect, the asset identifier is created and entered manually into the asset record. The asset record can include additional information about the asset including, for example, a description of the asset, manufacturer, serial number, part number, date designed, date installed, maintenance instructions, location information, and the like. In one aspect, the asset identifier is created as part of the asset record for a version of a graphical information system (GIS) database. At step 406, at least the asset identifier is sent to an asset identity management server 102. In one aspect, the asset identifier is sent to the asset identity management server 102 over a network 106. The asset identity management server determines whether the asset identifier has been previously stored in an asset identity management database 104 on the asset identity management server 102. At step 408, the computing device 108 receives a notice if the asset identifier has been previously stored in the asset identity management database on the asset identity management server, else the asset identifier is stored in the asset identity management database 104 on the asset identity management server 102 if the asset identifier has not been previously stored in the asset identity management database 104 on the asset identity management server 102. In one aspect, the notice can include information about an asset identified by the previously stored asset identifier. In one aspect, if the asset identifier had not been previously stored in the asset identity management database 104, a global identifier can be assigned to an asset identified by the asset identifier and the global identifier stored in the asset identity management database 104. In one aspect, the global identifier can be received by the computing device 108. In one aspect, the process can further include merging the version 110 back into the database 114.

As described above and as will be appreciated by one skilled in the art, embodiments of the present invention may be configured as a system, method, or computer program product. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable non-transitory computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as the one or more processors 203 discussed above with reference to FIG. 2, to produce a machine, such that the instructions which execute on the computer or other programmable data processing apparatus create a means for implementing the functions specified in the flowchart block or blocks.

These computer program instructions may also be stored in a non-transitory computer-readable memory that can direct a computer or other programmable data processing apparatus (e.g., one or more processors 203 of FIG. 2) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications may be referenced. The disclosures of these publications in their entireties are hereby incorporated by reference into this application in order to more fully describe the state of the art to which the methods and systems pertain.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving an asset identifier, wherein the asset identifier is created as part of an asset record for a version of a version managed database;
determining, using a processor, whether the asset identifier has been previously stored in an asset identity management database;
sending a notice if the asset identifier has been previously stored in the asset identity management database; and
storing at least the asset identifier in the asset identity management database if the asset identifier has not been previously stored in the asset identity management database.

2. The method of claim 1, wherein receiving the asset identifier, wherein the asset identifier is created as part of an asset record for a version of a version managed database comprises the asset identifier being automatically generated based upon information about an asset.

3. The method of claim 1, wherein receiving the asset identifier, wherein the asset identifier is created as part of an asset record for a version of a version managed database comprises the asset identifier being entered by a person.

4. The method of claim 1, wherein the asset identifier is created as part of the asset record for a version of a graphical information system (GIS) database.

5. The method of claim 1, wherein sending a notice if the asset identifier has been previously stored in the asset identity management database comprises sending the notice that includes information about an asset identified by the previously stored asset identifier.

6. The method of claim 1, wherein sending a notice if the asset identifier has been previously stored in the asset identity management database comprises sending the notice over a network to a separate computing device.

7. The method of claim 1, wherein sending a notice if the asset identifier has been previously stored in the asset identity management database comprises sending the notice to a sender of the asset identifier.

8. The method of claim 1, wherein storing at least the asset identifier in the asset identity management database if the asset identifier has not been previously stored in the asset identity management database further comprises assigning a global identifier to an asset identified by the asset identifier and storing the global identifier in the asset identity management database

9. The method of claim 8, further comprising sending the global identifier to a sender of the asset identifier.

10. A method comprising:
creating a version of a version managed database;
creating an asset record for an asset to be added to the version of the version managed database, wherein the asset record includes an asset identifier;
sending at least the asset identifier to an asset identity management server, wherein the asset identity management server determines whether the asset identifier has been previously stored in an asset identity management database on the asset identity management server; and
receiving a notice if the asset identifier has been previously stored in the asset identity management database on the asset identity management server.

11. The method of claim 10, further comprising storing at least the asset identifier in the asset identity management database on the asset identity management server if the asset identifier has not been previously stored in the asset identity management database on the asset identity management server

12. The method of claim 11, wherein storing at least the asset identifier in the asset identity management database if the asset identifier has not been previously stored in the asset identity management database further comprises assigning a global identifier to an asset identified by the asset identifier and storing the global identifier in the asset identity management database

13. The method of claim 12, further comprising receiving the global identifier sent by the asset identity management server.

14. The method of claim 10, further comprising merging the version back into the version managed database.

15. The method of claim 10, wherein creating the asset record for an asset to be added to the version of the version managed database that includes the asset identifier comprises the asset identifier being automatically generated based upon information about an asset.

16. The method of claim 10, wherein creating the asset record for an asset to be added to the version of the version managed database that includes the asset identifier comprises the asset identifier being entered by a person.

17. The method of claim 10, wherein the asset identifier is created as part of the asset record for a version of a graphical information system (GIS) database.

18. The method of claim 10, wherein receiving a notice if the asset identifier has been previously stored in the asset identity management database comprises receiving the notice that includes information about an asset identified by the previously stored asset identifier.

19. The method of claim 10, wherein receiving a notice if the asset identifier has been previously stored in the asset identity management database comprises receiving the notice over a network from the asset identity management server.

20. A system comprised of:
a communication interface;
a memory; and
a processor, wherein the processor is operably connected with the communication interface and the memory, and the processor is configured to:
receive an asset identifier, wherein the asset identifier is created as part of an asset record for a version of a version managed database;
determine whether the asset identifier has been previously stored in an asset identity management database stored on the memory;
send a notice using the communication interface if the asset identifier has been previously stored in the asset identity management database stored on the memory; and
store at least the asset identifier in the asset identity management database on the memory if the asset identifier has not been previously stored in the asset identity management database.

21. A system comprised of:
a communication interface;
a memory; and
a processor, wherein the processor is operably connected with the communication interface and the memory, and the processor is configured to:
create a version of a version managed database;
create an asset record for an asset to be added to the version of the version managed database, wherein the asset record includes an asset identifier;
send, using the communication interface, at least the asset identifier to an asset identity management server, wherein the asset identity management server determines whether the asset identifier has been previously stored in an asset identity management database on the asset identity management server; and
receive, using the communication interface, a notice if the asset identifier has been previously stored in the asset identity management database on the asset identity management server.

22. The system of claim 21, wherein the at least the asset identifier is stored in the asset identity management database on the asset identity management server if the asset identifier has not been previously stored in the asset identity management database on the asset identity management server

23. A system comprised of:
an asset identity management server, wherein the asset identity management server is associated with an asset identity management database;
a network, wherein the network is operably connected to the asset identity management server; and
a computing device, wherein the computing device is operably connected to the network, and wherein the computing device is configured to:
create a version of a version managed database;
create an asset record for an asset to be added to the version of the version managed database, wherein the asset record includes an asset identifier;
send at least the asset identifier over the network to the asset identity management server; and
receive a notice over the network from the asset identity management server if the asset identifier has been previously stored in the asset identity management database on the asset identity management server, wherein the asset identity management server is configured to:
receive the asset identifier sent by the computing device over the network and determine whether the asset identifier has been previously stored in the asset identity management database on the asset identity management server;
send a notice over the network to the computing device if the asset identifier has been previously stored in the asset identity management database; and
store at least the asset identifier in the asset identity management database if the asset identifier has not been previously stored in the asset identity management database.
